(19) United States
(12) Patent Application Publication
(10) Pub. No.: US 2026/0212852 A1
(43) Pub. Date: Jul. 23, 2026

(54) SOUND ABSORPTION AND INSULATION STRUCTURE

(71) Applicant: MITSUBISHI HEAVY INDUSTRIES, LTD., Tokyo (JP)

(72) Inventor: Yuki Ishii, Tokyo (JP)

(73) Assignee: MITSUBISHI HEAVY INDUSTRIES, LTD., Tokyo (JP)

(21) Appl. No.: 19/138,991

(22) PCT Filed: Nov. 22, 2023
(86) PCT No.: PCT/JP2023/041907

§ 371 Date: Jun. 13, 2025

(30) Foreign Application Priority Data
Dec. 23, 2022 (JP) 2022-206227

(51) Int. Cl. G10K 11/16

(52) U.S. Cl. CPC G10K 11/16

(57) ABSTRACT

A sound absorption and insulation structure includes: a first surface; a second surface disposed opposite the first surface; a first hole that is open on the first surface and is not open on the second surface; and a second hole that is open on the first surface and is not open on the second surface, the second hole differing from the first hole in shape and length.

### TECHNICAL FIELD

The present disclosure relates to a sound absorption and insulation structure. The present application claims priority based on Japanese Patent Application No. 2022-206227 filed on Dec. 23, 2022, the entire content of which is incorporated herein by reference.

### BACKGROUND ART

Patent Document 1 discloses a lightweight sound insulation structure with one or more sound insulation cells. In this sound insulation structure, each of the one or more sound insulation cells has a frame with a through hole, a film fixed to the frame, and an opening portion consisting of one or more holes perforated in the film, with both ends of the through hole in the frame not being closed. This sound insulation structure has a shielding peak frequency, which is determined by the opening portion of the one or more sound insulation cells and at which the transmission loss is maximized, lower than the first natural frequency of the film of the one or more sound insulation cells and selectively insulates sound in a predetermined frequency band around the shielding peak frequency.

### CITATION LIST

### Patent Literature

Patent Document 1: WO2016/136973A

### SUMMARY

### Problems to be Solved

The sound insulation structure described in Patent Document 1 uses a film as described above, so there is concern that deformation or damage to the film may cause changes in sound absorption and insulation performance, which poses a reliability issue in achieving stable sound absorption and insulation performance.

In view of the above, an object of at least one embodiment of the present disclosure is to provide a highly reliable sound absorption and insulation structure that can achieve stable sound absorption and insulation performance.

### Solution to the Problems

In order to achieve the above-described object, a sound absorption and insulation structure according to at least one embodiment of the present disclosure includes: a first surface; a second surface disposed opposite the first surface; a first hole that is open on the first surface and is not open on the second surface; and a second hole that is open on the first surface and is not open on the second surface, the second hole differing from the first hole in shape and length.

### Advantageous Effects

At least one embodiment of the present disclosure provides a highly reliable sound absorption and insulation structure that can achieve stable sound absorption and insulation performance.

### BRIEF DESCRIPTION OF DRAWINGS

FIG. 1 is a schematic perspective view of a sound absorption and insulation structure 2A according to an embodiment.

FIG. 2 is a schematic perspective view of an example of a sound absorption and insulation structure unit part 4 shown in FIG. 1.

FIG. 3 is a schematic cross-sectional view of the sound absorption and insulation structure unit part 4 in a cross-section along the direction in which three types of holes 9 are aligned (cross-section including the axis of each of the three types of holes 9).

FIG. 4 is a graph showing an example of the sound absorption performance of the sound absorption and insulation structure 2A.

FIG. 5 is a graph showing an example of the sound insulation performance of the sound absorption and insulation structure 2A.

FIG. 6 is a schematic perspective view of a sound absorption and insulation structure 2B according to another embodiment.

FIG. 7 is a schematic perspective view of an example of the internal structure of a sound absorption and insulation structural layer 24 shown in FIG. 6.

FIG. 8 is an exemplary cross-sectional view of the sound absorption and insulation structure 2B shown in FIG. 6, taken perpendicular to the axial direction.

FIG. 9 is a cross-sectional view taken along line A-A in FIG. 8.

FIG. 10 is a graph showing an example of the sound insulation performance of the sound absorption and insulation structure 2B.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

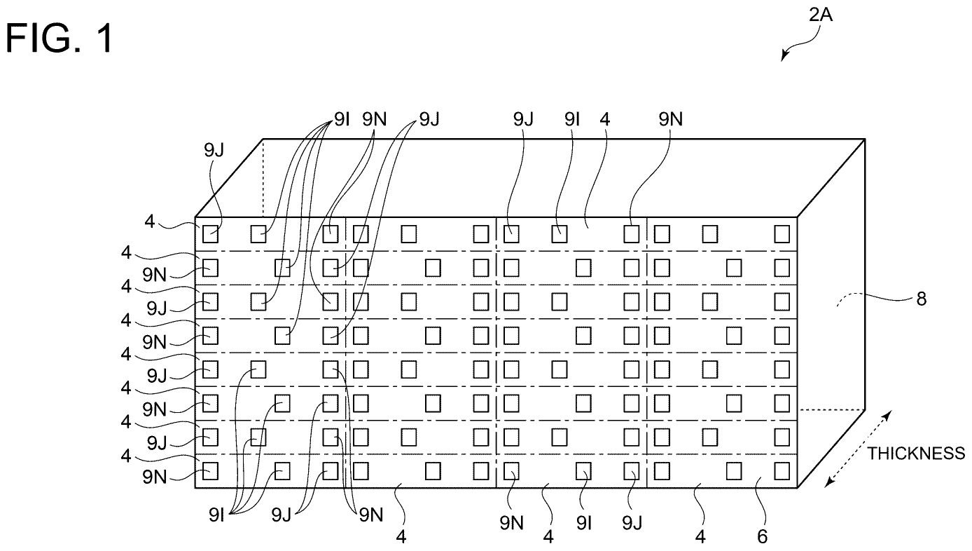

FIG. 1 is a schematic perspective view of a sound absorption and insulation structure 2A according to an embodiment. The sound absorption and insulation structure 2A may be used to absorb and insulate (sound absorption and sound insulation) noise from a rotating body, such as fans, for example. In the exemplary embodiment shown in FIG. 1, the sound absorption and insulation structure 2A is a wall-like structure formed along a plane, but the shape of the sound absorption and insulation structure is not limited and may be box-like, for example, to cover the source of noise.

In the exemplary embodiment shown in FIG. 1, the sound absorption and insulation structure 2A has a planar first surface 6 and a planar second surface 8 located on the opposite side from the first surface 6 (in FIG. 1, on the far side of the paper), and the thickness of the sound absorption and insulation structure 2A is defined by the first surface 6 and the second surface 8. The sound absorption and insulation structure 2A has a plurality of holes 9 that are open on the first surface 6. Each of the plurality of holes 9 is open only on the first surface 6 and not on the second surface 8 of the sound absorption and insulation structure 2A.

In the exemplary embodiment shown in FIG. 1, the sound absorption and insulation structure 2A is formed as a wall-like structure by arranging a plurality of cuboid sound absorption and insulation structure unit parts 4, each with three types of holes 9, along a plane, using these sound absorption and insulation structure unit parts 4 as the smallest structural units. The plurality of sound absorption and insulation structure unit parts 4 need not be formed as separate parts independent of each other, and the sound absorption and insulation structure 2A may be integrally formed by a 3D printer, for example, or may be manufactured by combining multiple parts produced by machining, etc. The method of manufacturing the sound absorption and insulation structure 2A is not limited.

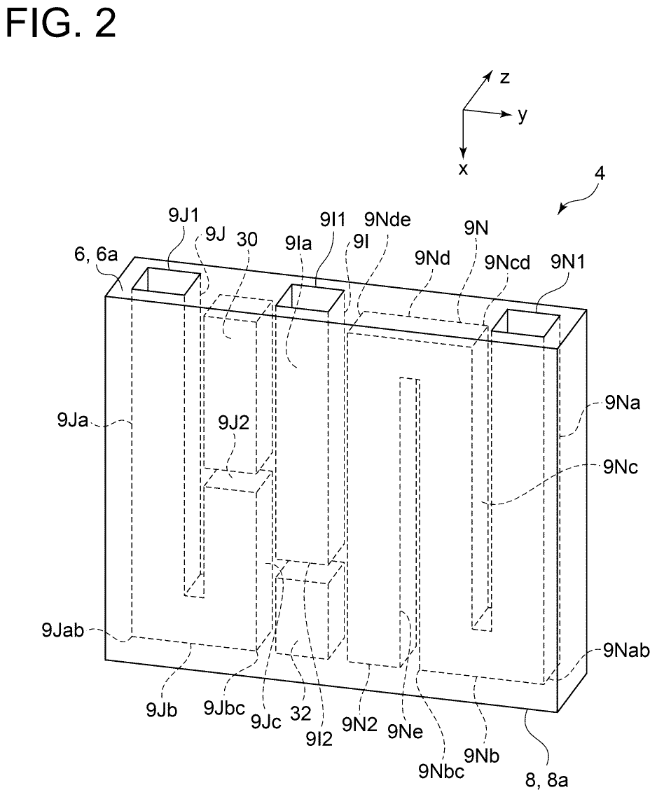

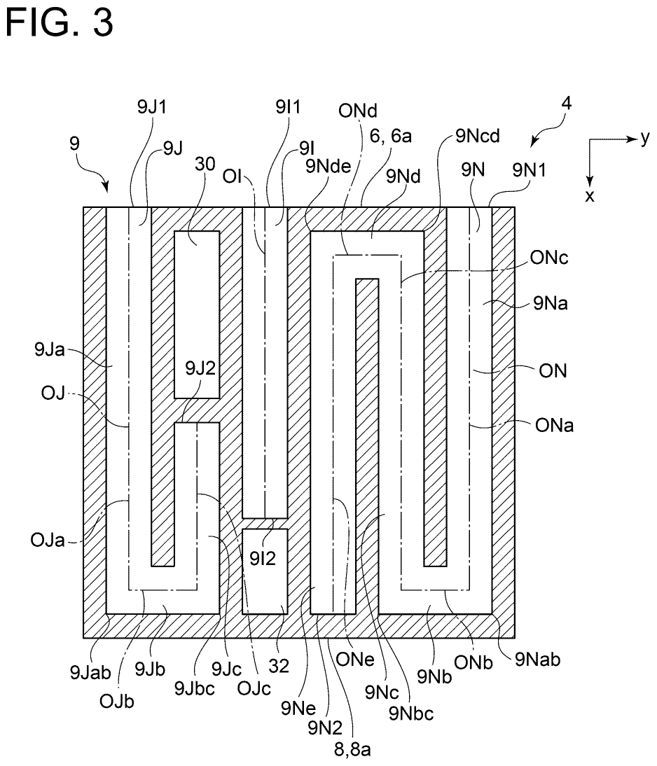

FIG. 2 is a schematic perspective view of an example of the sound absorption and insulation structure unit part 4 shown in FIG. 1. FIG. 3 is a schematic cross-sectional view of the sound absorption and insulation structure unit part 4 in a cross-section along the direction in which the three types of holes 9 are aligned (cross-section including the axis of each of the three types of holes 9).

As shown in FIGS. 2 and 3, the sound absorption and insulation structure unit part 4 includes a hole 9N, a hole 9J, and a hole 9I as the three types of holes 9. The holes 9N, 9J, and 9I are formed inside the sound absorption and insulation structure unit part 4 along the same plane including the thickness direction of the sound absorption and insulation structure 2A and differ in shape and length from each other. Specifically, the length of the hole 9N is different from the length of the hole 9J, the length of the hole 9J is different from the length of the hole 9I, and the length of the hole 9I is different from the length of the hole 9N. Further, the shape of the hole 9N is different from the shape of the hole 9J, the shape of the hole 9J is different from the shape of the hole 9I, and the shape of the hole 9I is different from the shape of the hole 9N.

The sound absorption and insulation structure unit part 4 includes a first surface part 6a that constitutes a part of the first surface 6 and a second surface part 8a that constitutes a part of the second surface 8 on the opposite side from the first surface part 6a. One end of the hole 9N is formed as an open end 9N1 that is open on the first surface part 6a, and the other end of the hole 9N is formed as a closed end 9N2 that is closed inside the sound absorption and insulation structure unit part 4. One end of the hole 9J is formed as an open end 9J1 that is open on the first surface part 6a, and the other end of the hole 9J is formed as a closed end 9J2 that is closed inside the sound absorption and insulation structure unit part 4. One end of the hole 9I is formed as an open end 911 that is open on the first surface part 6a, and the other end of the hole 9I is formed as a closed end 912 that is closed inside the sound absorption and insulation structure unit part 4. Each of the holes 9N, 9J, and 91 is open only on the first surface part 6a and not on the second surface part 8a. That is, each of the holes 9N, 9J, and 9I is open only on the first surface 6 and not on the second surface 8.

In the example shown in FIGS. 2 and 3, for convenience, the direction normal to the first surface part 6a (the direction normal to the first surface 6), i.e., the thickness direction of the sound absorption and insulation structure 2A is defined as the x-direction, the direction perpendicular to the x-direction in which the holes 9J, 9I and 9N in the sound absorption and insulation structure unit part 4 are aligned on the first surface part 6a (more specifically, the direction in which the open end 9J1 of the hole 9J, the open end 911 of the hole 9I, and the open end 9N1 of the hole 9N are aligned on the first surface part 6a) is defined as the y-direction, and the direction perpendicular to each of the x-direction and the y-direction is defined as the z-direction. In the illustrated example, the holes 9J, 9I, and 9N are aligned along the y-direction in this order, but the order of the holes 9J, 9I, and 9N is not limited to the illustrated example.

In the cross-section shown in FIG. 3 (cross-section perpendicular to the z-direction), the hole 9N is formed in an N-shape, the hole 9J is formed in a J-shape, and the hole 9I is formed in an I-shape (linearly). That is, the axis ON of the hole 9N, which defines the length of the hole 9N, extends in an N-shape, the axis OJ of the hole 9J, which defines the length of the hole 9J, extends in a J-shape, and the axis OI of the hole 9I, which defines the length of the hole 9I, extends in an I-shape (linearly). In the illustrated exemplary embodiment, each of the axes ON, OJ, and OI extends along a plane perpendicular to the z-direction.

The hole 9N includes a plurality of passage parts connected in series: a linear part 9Na, a linear part 9Nb, a linear part 9Nc, a linear part 9Nd, and a linear part 9Ne. Each of the linear part 9Na, the linear part 9Nb, the linear part 9Nc, the linear part 9Nd, and the linear part 9Ne is a cavity formed inside the sound absorption and insulation structure unit part 4. In the illustrated example, the cross-section of the linear part 9Na perpendicular to the x-direction is rectangle, the cross-section of the linear part 9Nb perpendicular to the y-direction is rectangle, the cross-section of the linear part 9Nc perpendicular to the x-direction is rectangle, the cross-section of the linear part 9Nd perpendicular to the y-direction is rectangle, and the cross-section of the linear part 9Ne perpendicular to the x-direction is rectangle.

One end of the linear part 9Na is open on the first surface 6, and the linear part 9Na extends from the first surface 6 toward the second surface 8 along the x-direction (direction intersecting the first surface 6). The end of the linear part 9Na on the side facing the second surface 8 is connected to one end of the linear part 9Nb. The linear part 9Nb extends from the end of the linear part 9Na on the side facing the second surface 8 toward the hole 9I along the y-direction (direction intersecting the direction of extension of the linear part 9Na). The end of the linear part 9Nb on the side away from the linear part 9Na is connected to one end of the linear part 9Nc. The linear part 9Nc extends from the end of the linear part 9Nb on the side away from the linear part 9Na toward the first surface 6 along the x-direction (direction intersecting the direction of extension of the linear part 9Nb). The end of the linear part 9Nc on the side facing the first surface 6 is connected to one end of the linear part 9Nd. The linear part 9Nd extends from the end of the linear part 9Nc on the side facing the first surface 6 toward the hole 9I along the y-direction (direction intersecting the direction of extension of the linear part 9Nc). The end of the linear part 9Nd on the side away from the linear part 9Nc is connected to the end of the linear part 9Ne on the side facing the first surface 6. The linear part 9Ne extends from the end of the linear part 9Nd on the side away from the linear part 9Nc toward the second surface 8 along the x-direction (direction intersecting the direction of extension of the linear part 9Nd). The end of the linear part 9Ne on the side facing the second surface 8 in the x-direction is not open on the second surface 8 and is closed as the closed end 9N2.

In the example shown in FIGS. 2 and 3, the connection between the linear part 9Na and the linear part 9Nb constitutes a bending part 9Nab in which the direction of extension of the hole 9N changes by 90 degrees, and the connection between the linear part 9Nb and the linear part 9Nc constitutes a bending part 9Nbc in which the direction of extension of the hole 9N changes by 90 degrees. Further, the connection between the linear part 9Nc and the linear part 9Nd constitutes a bending part 9Ncd in which the direction of extension of the hole 9N changes by 90 degrees, and the connection between the linear part 9Nd and the linear part 9Ne constitutes a bending part 9Nde in which the direction of extension of the hole 9N changes by 90 degrees.

Thus, the hole 9N is composed of the linear part 9Na, the linear part 9Nb, the linear part 9Nc, the linear part 9Nd, and the linear part 9Ne connected in series, forming an N-shape in a cross-section perpendicular to the z-direction.

The hole 9J includes a plurality of passage parts connected in series: a linear part 9Ja, a linear part 9Jb, and a linear part 9Jc. Each of the linear part 9Ja, the linear part 9Jb, and the linear part 9Jc is a cavity formed inside the sound absorption and insulation structure unit part 4. In the illustrated example, the cross-section of the linear part 9Ja perpendicular to the x-direction is rectangle, the cross-section of the linear part 9Jb perpendicular to the y-direction is rectangle, and the cross-section of the linear part 9Jc perpendicular to the x-direction is rectangle.

One end of the linear part 9Ja is open on the first surface 6, and the linear part 9Ja extends from the first surface 6 toward the second surface 8 along the x-direction. The end of the linear part 9Ja on the side facing the second surface 8 is connected to one end of the linear part 9Jb. The linear part 9Jb extends from the end of the linear part 9Ja on the side facing the second surface 8 toward the hole 9I along the y-direction (direction intersecting the direction of extension of the linear part 9Ja). The end of the linear part 9Jb on the side away from the linear part 9Ja is connected to the end of the linear part 9Jc on the side facing the second surface 8. The linear part 9Jc extends from the end of the linear part 9Jb on the side away from the linear part 9Ja toward the first surface part 6a along the x-direction. The end of the linear part 9Jc on the side facing the first surface 6 in the x-direction is not open on the first surface 6 and is closed as the closed end 9J2.

In the example shown in FIGS. 2 and 3, the connection between the linear part 9Ja and the linear part 9Jb constitutes a bending part 9Jab in which the direction of extension of the hole 9J changes by 90 degrees, and the connection between the linear part 9Jb and the linear part 9Jc constitutes a bending part 9Jbc in which the direction of extension of the hole 9J changes by 90 degrees.

Thus, the hole 9J is composed of the linear part 9Ja, the linear part 9Jb, and the linear part 9Jc, forming a J-shape in a cross-section perpendicular to the z-direction.

The hole 9I is a cavity formed inside the sound absorption and insulation structure unit part 4. The hole 9I is composed only of a linear part 9Ia extending linearly from the first surface 6 along the x-direction. In the illustrated example, the cross-section of the hole 9I perpendicular to the x-direction is rectangle. One end of the hole 9I is open on the first surface 6, and the end of the hole 9I on the side facing the second surface 8 is not open on the second surface 8 and is closed as a closed end 912. The hole 9I is formed in an I-shape (linearly) in a cross-section perpendicular to the x-direction.

In the above-described sound absorption and insulation structure 2A, L1≠L2≠L3 is satisfied, where L1 is the length of the hole 9N, L2 is the length of the hole 9J, L3 is the length of the hole 9I, and L1, L2, and L3 are different lengths from each other. For example, the length L1 of the hole 9N may be about twice (e.g., not less than 1.5 times and not more than 2.5 times) as long as the length L2 of the hole 9J, and the length L2 of the hole 9J may be about twice (e.g., not less than 1.5 times and not more than 2.5 times) as long as the length L3 of the hole 9I. The length L1 of the hole 9N may be not less than 1.8 times and not more than 2.2 times as long as the length L2 of the hole 9J, and the length L2 of the hole 9J may be not less than 1.8 times and not more than 2.2 times as long as the length L3 of the hole 9I.

In the configuration shown in FIG. 3, the length L1 of the hole 9N is the sum of LNa, LNb, LNc, LNd, and LNe, satisfying L1=LNa+LNb+LNc+LNd+LNe, where LNa is the length of the axis ONa of the linear part 9Na, LNb is the length of the axis of the linear part 9Nb, LNc is the length of the axis ONc of the linear part 9Nc, LNd is the length of the axis ONd of the linear part 9Nd, and LNe is the length of the axis ONe of the linear part 9Ne. The length L2 of the hole 9J is the sum of LJa, LJb, and LJc, satisfying L2=LJa+LJb+LJc, where LJa is the length of the axis OJa of the linear part 9Ja, LJb is the length of the axis OJb of the linear part 9Jb, and LJc is the length of the axis OJc of the linear part 9Jc. The length L3 of the hole 9I is the length of the axis OI of the linear part 9Ia.

In the exemplary embodiment shown in FIGS. 2 and 3, etc., the sound absorption and insulation structure unit part 4 includes a cavity 30 and a cavity 32. The cavity 30 is formed between the linear part 9Ja and the linear part 9Ia and between the closed end 9J2 of the linear part 9Jc and the first surface 6. The cavity 32 is formed between the linear part 9Jc and the linear part 9Ne and between the closed end 912 of the linear part 9Ia and the second surface 8.

With the sound absorption and insulation structure 2A, as compared to the sound insulation structure described in Patent Document 1, the use of the plurality of holes 9 with different shapes and lengths provides the sound absorption and insulation effect without a film, enabling a highly reliable sound absorption and insulation structure 2A that can achieve stable sound absorption and insulation performance.

Additionally, with the sound absorption and insulation structure 2A, the target frequencies of sound absorption and sound insulation (frequencies at which the sound absorption coefficient reaches its maximum) of each of the holes 9N, 9J, and 9I can be different from each other, and these three types of holes 9N, 9J, and 9I can achieve high sound absorption and insulation performance for frequencies that include higher order components (1st to 6th, 7th and 9th order, etc.) of rotating bodies.

For each of the plurality of holes 9 formed in the sound absorption and insulation structure 2A, the relationship between the length L of the hole 9 and the target frequency fᵣ (frequency at which the sound absorption coefficient reaches its maximum) of the hole 9 can be expressed by the following equation (A):

$${f}_{r} = ( 2 n + 1 ) \times {c}_{0} \times n / ( 4 L ) \qquad ( A )$$

where n is a natural number, and co is the speed of sound in standard atmosphere.

Accordingly, in the hole 9N, for example, if the length L1 of the hole 9N is about 85 mm and substituted for L in equation (A), the target frequency fr of the hole 9N is about 1 kHz, 3 kHz, 5 kHz, . . . . In the hole 9J, for example, if the length L2 of the hole 9J is about 43 mm and substituted for L in equation (A), the target frequency fr of the hole 9J is about 2 kHz, 6 kHz, 10 kHz, . . . . In the hole 9I, for example, if the length L3 of the hole 9I is about 21 mm and substituted for L in equation (A), the target frequency fr of the hole 9I is about 4 kHz, 12 kHz, 20 kHz, . . . . In practice, the relationship between the length of the hole 9L and the target frequency fr may deviate slightly from the above equation (A) due to interactions between the plurality of holes 9 caused by sound pressure or other factors. In this case, the length of each of the holes 9N, 9J, and 9I should be fine-tuned as appropriate.

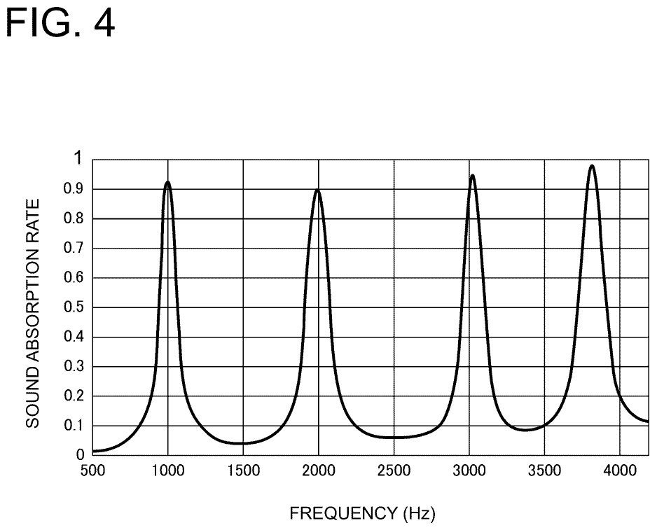

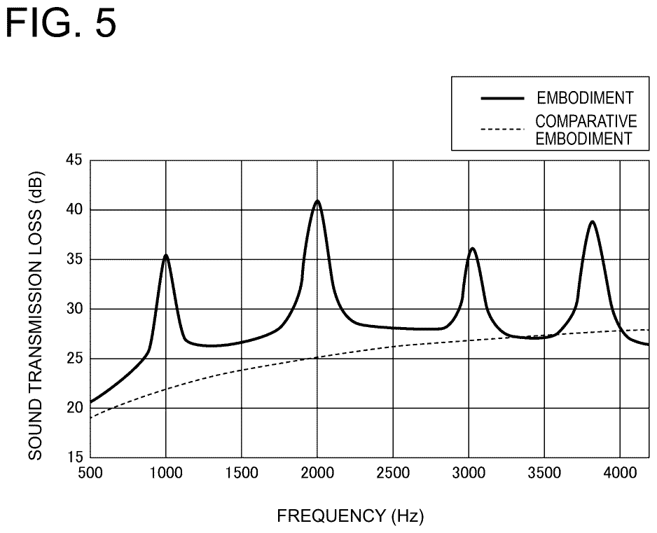

FIG. 4 is a graph showing an example of the sound absorption performance of the sound absorption and insulation structure 2A, showing an example of the relationship between frequency and sound absorption rate in the sound absorption and insulation structure 2A. FIG. 5 is a graph showing an example of the sound insulation performance of the sound absorption and insulation structure 2A, showing an example of the relationship between frequency and sound transmission loss in the sound absorption and insulation structure 2A. The examples of FIGS. 4 and 5 show the sound absorption performance and the sound insulation performance of the sound absorption and insulation structure 2A when the thickness of the sound absorption and insulation structure 2A (i.e., the distance between the first surface 6 and the second surface 8) is about 30 mm, the length of the hole 9N is about 85 mm, the length of the hole 9J is about 43 mm, and the length of the hole 9I is about 21 mm. The comparative embodiment in FIG. 5 shows the sound transmission loss of a sound absorption and insulation structure when the plurality of holes 9 are not provided in the sound absorption and insulation structure 2A.

As shown in FIGS. 4 and 5, with the sound absorption and insulation structure 2A, the holes 9N, 9J, and 9I provide high sound absorption and insulation performance for frequencies (in the illustrated example, about 1 kHz, 2 kHz, 3 kHz, 4 kHz, 5 kH, 6 kHz, 7 kHz, 9 kHz, . . . ) that include higher-order components (1st to 6th, 7th, 9th order, . . . ) of rotating bodies such as fans.

For example, in the case of the sound insulation structure described in Patent Document 1, if the sound absorption and insulation effect is to be achieved even for the higher-order components of rotating bodies, it is necessary to install many types of sound insulation cells with different properties such as film rigidity. However, in a limited space, the number of sound insulation cells for each target frequency tends to be small, making it difficult to achieve sufficient sound absorption and insulation effect without increasing the overall dimensions of the sound insulation structure. In contrast, the sound absorption and insulation structure 2A can achieve the sound absorption effect and the sound insulation effect over a wide range of target frequencies using only a small number of types of holes 9 (in the illustrated example, three types of holes 9N, 9J, and 91). As a result, even in a limited space, a large number of holes 9 can be provided for each target frequency. Therefore, it is possible to achieve a high sound absorption and insulation effect for frequencies including higher-order components of rotating bodies, while minimizing the size of the sound absorption and insulation structure 2A.

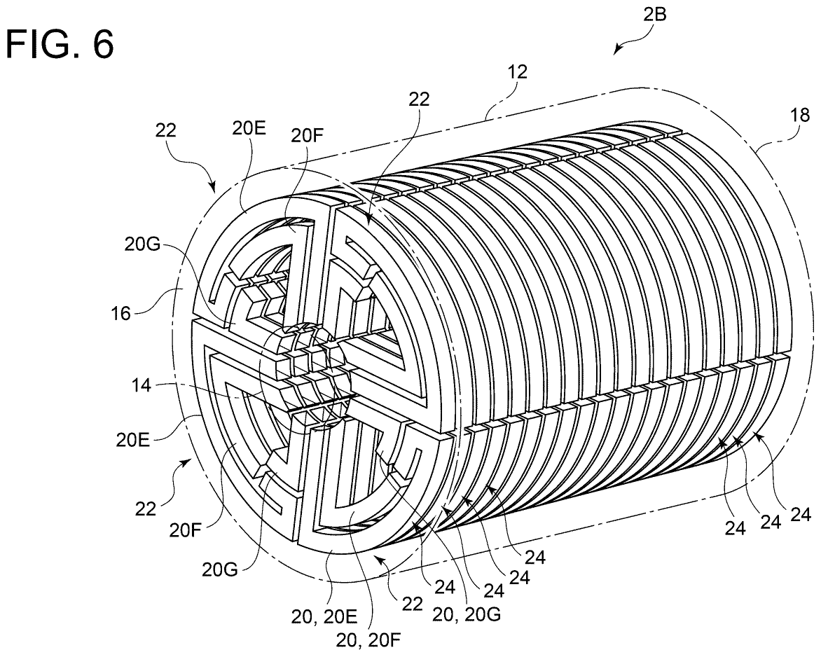

FIG. 6 is a schematic perspective view of a sound absorption and insulation structure 2B according to another embodiment. In the exemplary embodiment shown in FIG. 6, the sound absorption and insulation structure 2B is of cylindrical shape. In FIG. 6, the outline of the outer surface of the cylindrical sound absorption and insulation structure 2B is shown by the dotted and dashed line, and the cavity formed inside the sound absorption and insulation structure 2B is shown by the solid line.

Hereinafter, “axial direction” or “axially” means the axial direction of the cylindrical shape of the sound absorption and insulation structure 2B unless otherwise specified, “circumferential direction” or “circumferentially” means the circumferential direction of the cylindrical shape unless otherwise specified, and “radial direction” or “radially” means the radial direction of the cylindrical shape unless otherwise specified.

As shown in FIG. 6, the sound absorption and insulation structure 2B includes an outer surface 12 (second surface), an inner surface 14 (first surface) located opposite the outer surface 12 in the radial direction, one end surface 16, which is an end surface at one end in the axial direction, and another end surface 18, which is an end surface at the other end in the axial direction.

The sound absorption and insulation structure 2B has a plurality of holes 20 that are open on the inner surface 14. Each of the plurality of holes 20 is open only on the inner surface 14 of the sound absorption and insulation structure 2B and not on any surface other than the inner surface (outer surface 12, one end surface 16 and other end surface 18) of the sound absorption and insulation structure 2B.

In the exemplary embodiment shown in FIG. 6, the sound absorption and insulation structure 2B is configured as an assembly of a plurality of sound absorption and insulation structure unit parts 22. The sound absorption and insulation structure 2B is composed of twenty sound absorption and insulation structural layers 24 stacked along the axial direction, each structural layer 24 made up of a set of four sound absorption and insulation structure unit parts 22 arranged along the circumferential direction, making a total of eighty sound absorption and insulation structure unit parts 22 formed as a single piece. Each of the sound absorption and insulation structure unit parts 22 need not be configured as separate components independent of each other, and each of the sound absorption and insulation structural layers 24 need not be configured as separate components independent of each other. The sound absorption and insulation structure 2B may be integrally formed by a 3D printer, for example, or may be manufactured by combining multiple parts produced by machining, etc. The method of manufacturing the sound absorption and insulation structure 2B is not limited.

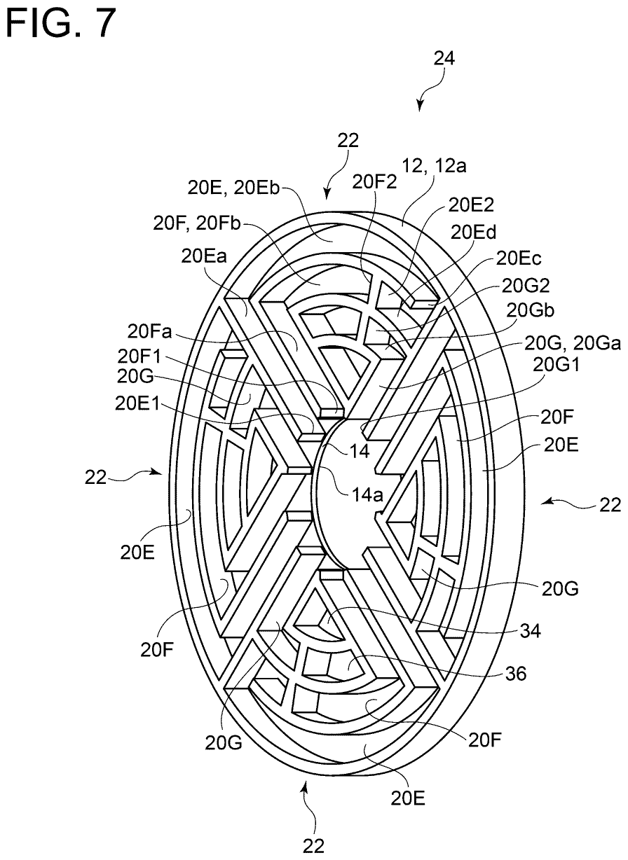

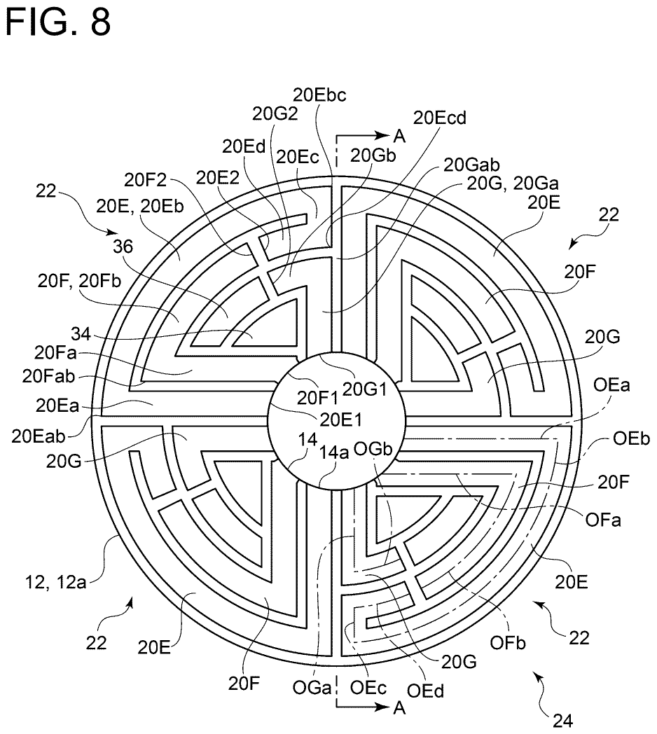

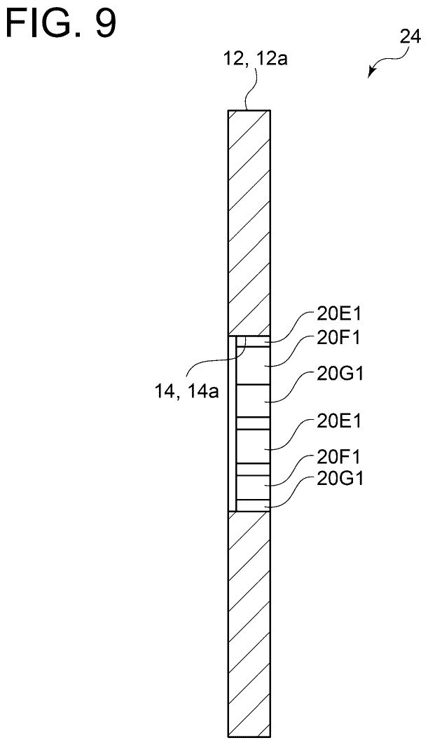

FIG. 7 is a schematic perspective view of an example of the internal structure of the sound absorption and insulation structural layer 24 shown in FIG. 6. FIG. 8 is an exemplary cross-sectional view of the sound absorption and insulation structure 2B shown in FIG. 6, taken perpendicular to the axial direction. FIG. 9 is a cross-sectional view taken along line A-A in FIG. 8.

For example, as shown in FIGS. 6 to 8, the sound absorption and insulation structure unit part 22 includes a hole 20E, a hole 20F, and a hole 20G as three types of holes 20 that constitute the plurality of holes 20. The holes 20E, 20F, and 20G are formed inside the sound absorption and insulation structure unit part 22 so as to extend along a plane perpendicular to the axial direction and differ in shape and length from each other. Specifically, the length of the hole 20E is different from the length of the hole 20F, the length of the hole 20F is different from the length of the hole 20G, and the length of the hole 20G is different from the length of the hole 20E. Further, the shape of the hole 20E is different from the shape of the hole 20F, the shape of the hole 20F is different from the shape of the hole 20G, and the shape of the hole 20G is different from the shape of the hole 20E.

For example, as shown in FIGS. 7 to 9, the sound absorption and insulation structure unit part 22 includes an inner surface part 14a that constitutes a part of the inner surface 14 and an outer surface part 12a that constitutes a part of the outer surface 12 on the opposite side from the inner surface part 14a. One end of the hole 20E is formed as an open end 20E1 that is open on the inner surface part 14a, and the other end of the hole 20E is formed as a closed end 20E2 that is closed inside the sound absorption and insulation structure unit part 22. One end of the hole 20F is formed as an open end 20F1 that is open on the inner surface part 14a, and the other end of the hole 20F is formed as a closed end 20F2 that is closed inside the sound absorption and insulation structure unit part 22. One end of the hole 20G is formed as an open end 20G1 that is open on the inner surface part 14a, and the other end of the hole 20G is formed as a closed end 20G2 that is closed inside the sound absorption and insulation structure unit part 22. Each of the holes 20E, 20F, and 20G is open only on the inner surface part 14a and not on the outer surface part 12a. That is, each of the holes 20E, 20F, and 20G is open only on the inner surface 14 and not on the outer surface 12.

For example, as shown in FIGS. 7 and 8, the hole 20E includes a plurality of passage parts connected in series: a linear part 20Ea, an arc-shaped part 20Eb, a linear part 20Ec, and an arc-shaped part 20Ed. Each of the linear part 20Ea, the arc-shaped part 20Eb, the linear part 20Ec, and the arc-shaped part 20Ed is a cavity formed inside the sound absorption and insulation structure unit part 4, and in the illustrated example, the cross-section of each of the linear parts 20Ea, 20Ec perpendicular to the radial direction is rectangle, and the cross-section of each of the arc-shaped parts 20Eb, 20Ed perpendicular to the circumferential direction is rectangle.

The radially inner end of the linear part 20Ea is open on the inner surface 14, and the linear part 20Ea extends from the inner surface 14 radially outward along the radial direction. The radially outer end of the linear part 20Ea is connected to one circumferential end of the arc-shaped part 20Eb. The arc-shaped part 20Eb extends from the radially outer end of the linear part 20Ea along the circumferential direction (direction intersecting the direction of extension of the linear part 20Ea) and is connected to the radially outer end of the linear part 20Ec. The linear part 20Ec extends from the end of the arc-shaped part 20Eb on the side away from the linear part 20Ea radially inward along the radial direction. The radially inner end of the linear part 20Ec (the end of the linear part 20Ec on the side away from the linear part 20Eb) is connected to one circumferential end of the arc-shaped part 20Ed. The arc-shaped part 20Ed extends from the radially inner end of the linear part 20Ec toward the linear part 20Ea along the circumferential direction. The other circumferential end of the arc-shaped part 20Ed is not open and is closed as a closed end 20E2.

In the illustrated example, the connection between the linear part 20Ea and the arc-shaped part 20Eb constitutes a bending part 20Eab in which the direction of extension of the hole 20E turns by 90 degrees, the connection between the arc-shaped part 20Eb and the linear part 20Ec constitutes a bending part 20Ebc in which the direction of extension of the hole 20E turns by 90 degrees, and the connection between the linear part 20Ec and the arc-shaped part 20Ed constitutes a bending part 20Ecd in which the direction of extension of the hole 20E turns by 90 degrees.

The hole 20F is located between the holes 20E and 20G and includes a plurality of passage parts connected in series: a linear part 20Fa and an arc-shaped part 20Fb. Each of the linear part 20Fa and the arc-shaped part 20Fb is a cavity formed inside the sound absorption and insulation structure unit part 4, and in the illustrated example, the cross-section of the linear parts 20Fa perpendicular to the radial direction is rectangle, and the cross-section of the arc-shaped parts 20Fb perpendicular to the circumferential direction is rectangle.

The linear part 20Fa is located between the linear part 20Ea of the hole 20E and the linear part 20Ga of the hole 20G. The radially inner end of the linear part 20Fa is open on the inner surface 14, and the linear part 20Fa extends from the inner surface 14 radially outward along the radial direction. The length of the linear part 20Fa is shorter than the length of the linear part 20Ea. The radially outer end of the linear part 20Fa is connected to one circumferential end of the arc-shaped part 20Fb. The arc-shaped part 20Fb is located inward of the arc-shaped part 20Eb of the hole 20E in the radial direction. The arc-shaped part 20Fb extends from the radially outer end of the linear part 20Fa toward the arc-shaped part 20Ed of the hole 20E along the circumferential direction (direction intersecting the direction of extension of the linear part 20Fa). The other circumferential end of the arc-shaped part 20Fb is not open and is closed as a closed end 20F2. In the illustrated example, the arc-shaped part 20Ed of the hole 20E and the arc-shaped part 20Fb of the hole 20F are formed at the same radial position and in different circumferential ranges.

In the illustrated example, the connection between the linear part 20Fa and the arc-shaped part 20Fb constitutes a bending part 20Fab in which the direction of extension of the hole 20F turns by 90 degrees.

The hole 20G includes a linear parts 20Ga and an arc-shaped parts 20Gb connected in series. Each of the linear part 20Ga and the arc-shaped part 20Gb is a cavity formed inside the sound absorption and insulation structure unit part 4, and in the illustrated example, the cross-section of the linear parts 20Ga perpendicular to the radial direction is rectangle, and the cross-section of the arc-shaped parts 20Gb perpendicular to the circumferential direction is rectangle.

The radially inner end of the linear part 20Ga is open on the inner surface 14, and the linear part 20Ga extends from the inner surface 14 radially outward along the radial direction. The length of the linear part 20Ga is shorter than the length of the linear part 20Fa. The radially outer end of the linear part 20Ga is connected to one circumferential end of the arc-shaped part 20Gb. The arc-shaped part 20Gb is located inward of each of the arc-shaped part 20Ed of the hole 20E and the arc-shaped part 20Fb of the hole 20F in the radial direction. The arc-shaped part 20Gb extends from the radially outer end of the linear part 20Ga toward the linear part 20Ga of the hole 20E along the circumferential direction (direction intersecting the direction of extension of the linear part 20Ga). The other circumferential end of the arc-shaped part 20Gd is not open and is closed as a closed end 20F2. In the illustrated example, the linear part 20Ga and the linear part 20Ec are located at the same circumferential position, and the linear part 20Ga is located inward of the linear part 20Ec in the radial direction. Further, at least part of the area where the arc-shaped part 20Gb is provided in the circumferential direction overlaps at least part of the area where the arc-shaped part 20Ed of the hole 20E is provided in the circumferential direction.

In the illustrated example, the connection between the linear part 20Ga and the arc-shaped part 20Gb constitutes a bending part 20Gab in which the direction of extension of the hole 20G turns by 90 degrees.

In the above-described sound absorption and insulation structure 2B, L1≠L2≠L3 is satisfied, where L1 is the length of the hole 20E, L2 is the length of the hole 20F, L3 is the length of the hole 20G, and L1, L2, and L3 are different lengths from each other. For example, the length L1 of the hole 20E may be about twice (e.g., not less than 1.5 times and not more than 2.5 times) as long as the length L2 of the hole 20F, and the length L2 of the hole 20F may be about twice (e.g., not less than 1.5 times and not more than 2.5 times) as long as the length L3 of the hole 20G. The length L1 of the hole 20E may be not less than 1.8 times and not more than 2.2 times as long as the length L2 of the hole 20F, and the length L2 of the hole 20F may be not less than 1.8 times and not more than 2.2 times as long as the length L3 of the hole 20G.

In the configuration shown in FIG. 8, the length L1 of the hole 20E is the sum of LEa, LEb, LEc, and LEd, satisfying L1=LEa+LEb+LEc+LEd, where LEa is the length of the axis OEa of the linear part 20Ea, LEb is the length of the axis of the arc-shaped part 20Eb, LEc is the length of the axis OEc of the linear part 20Ec, and LEd is the length of the axis OEd of the arc-shaped part 20Ed. The length L2 of the hole 20F is the sum of LFa and LFb, satisfying L2=LFa+LFb, where LFa is the length of the axis OFa of the linear part 20Fa, and LFb is the length of the axis OFb of the arc-shaped part 20Fb. The length L3 of the hole 20G is the sum of LGa and LGb, satisfying L3=LGa+LGb, where LGa is the length of the axis OGa of the linear part 20Ga, and LGb is the length of the axis OGb of the arc-shaped part 20Gb.

In the exemplary embodiment shown in FIGS. 7 and 8, etc., the sound absorption and insulation structure unit part 4 includes a cavity 34 and a cavity 36 between the hole 20F and the hole 20G. The cavity 34 is formed between the linear part 20Fa and the linear part 20Ga. The cavity 36 is formed at the position between the cavity 34 and the arc-shaped part 20Fb in the radial direction and between the linear part 20Fa and the arc-shaped part 20Gb in the circumferential direction.

With the sound absorption and insulation structure 2B, as compared to the sound insulation structure described in Patent Document 1, the use of the plurality of holes 9 with different shapes and lengths provides the sound absorption and insulation effect without a film, enabling a highly reliable sound absorption and insulation structure 2B that can achieve stable sound absorption and insulation performance.

For each of the plurality of holes 20 formed in the sound absorption and insulation structure 2B, the relationship between the length L of the hole 20 and the target frequency fᵣ (frequency at which the sound absorption coefficient reaches its maximum) of the hole 20 can be expressed by the above equation (A).

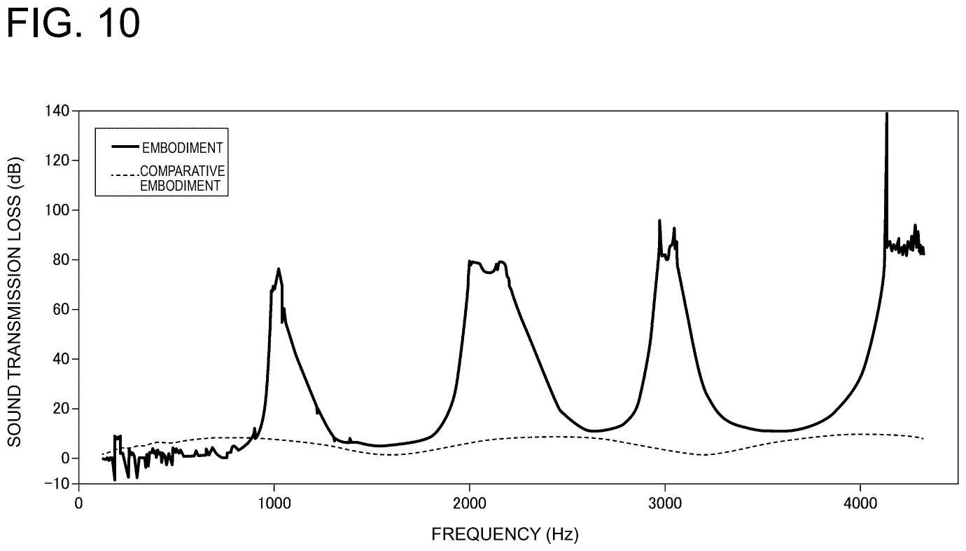

FIG. 10 is a graph showing an example of the sound insulation performance of the sound absorption and insulation structure 2B, showing an example of the relationship between frequency and sound transmission loss in the sound absorption and insulation structure 2B. The embodiment in FIG. 10 shows the sound insulation performance of the sound absorption and insulation structure 2B for a sine sweep signal when the length L1 of the hole 20E is about 85 mm, the length L2 of the hole 20F is about 43 mm, and the length L3 of the hole 20G is about 21 mm. The comparative embodiment in FIG. 10 shows the sound insulation performance of a sound absorption and insulation structure for a sine sweep signal when the plurality of holes 20 are not provided in the sound absorption and insulation structure 2B. As shown in FIG. 10, with the sound absorption and insulation structure 2B, the holes 20E, 20F, and 20G provide high sound absorption and insulation performance for frequencies (in the illustrated example, 1 kHz, 2 kHz, 3 kHz, 4 kHz, 5kH, 6 kHz, 7 kHz, 9 kHz, . . . ) that include higher-order components (1st to 6th, 7th, 9th order, . . . ) of rotating bodies such as fans.

As with the sound absorption and insulation structure 2A, the sound absorption and insulation structure 2B can achieve the sound absorption effect and the sound insulation effect over a wide range of target frequencies using only a small number of types of holes 9 (in the illustrated example, three types of holes 20E, 20F, and 20G). As a result, even in a limited space, a large number of holes 20 can be provided for each target frequency. Therefore, it is possible to achieve a high sound absorption and insulation effect for frequencies including higher-order components of rotating bodies, while minimizing the size of the sound absorption and insulation structure 2B.

Additionally, noise can be effectively reduced by the holes 20E, 20F, and 20G formed on the inner surface 14 when the noise passes on the side of the inner surface 14 of the sound absorption and insulation structure 2B from one axial end of the cylindrical sound absorption and insulation structure 2B. Therefore, by installing the sound absorption and insulation structure 2B in, for example, an opening of a casing that covers a rotating body to be subjected to noise reduction, the noise emitted from the opening can be effectively reduced.

The present disclosure is not limited to the embodiments described above, but includes modifications to the embodiments described above, and embodiments composed of combinations of those embodiments.

For example, in some embodiments described above, the sound absorption and insulation structure has three types of holes (first, second, and third holes) of different shapes and lengths, but the number of types of holes provided in the sound absorption and insulation structure is not limited to three, but may be two or four or more, for example.

The contents described in the above embodiments would be understood as follows, for instance.
(1) A sound absorption and insulation structure (e.g., the above-described sound absorption and insulation structure 2A, 2B) according to at least one embodiment of the present disclosure includes: a first surface (e.g., the above-described first surface 6, inner surface 14); a second surface (e.g., the above-described second surface 8, outer surface 12) disposed opposite the first surface; a first hole (e.g., the above-described holes 9N, 9J, 9I and holes 20E, 20F, 20G) that is open on the first surface and is not open on the second surface; and a second hole (e.g., holes other than the first hole of the above-described holes 9N, 9J, 9I, 20E, 20F, 20G) that is open on the first surface and is not open on the second surface, the second hole differing from the first hole in shape and length.

With the sound absorption and insulation structure described in (1), since the first hole and the second hole are open on the first surface and are not open on the second surface, sound waves transmitted through each of the first hole and the second hole reflect off the fixed end. In this context, since the first hole and the second hole differ in shape and length, the sound absorption and insulation effects can be obtained for different frequencies, and high sound absorption and insulation performance can be achieved, for example, for frequencies that include higher-order components of rotating bodies such as fans. Additionally, as compared to the sound insulation structure described in Patent Document 1, the use of the first hole and the second hole with different shapes and lengths provides the sound absorption and insulation effect without a film, enabling a highly reliable sound absorption and insulation structure that can achieve stable sound absorption and insulation performance.

For example, in the case of the sound insulation structure described in Patent Document 1, if the sound absorption and insulation effect is to be achieved even for the higher-order components of rotating bodies, it is necessary to install many types of sound insulation cells with different properties such as film rigidity. However, in a limited space, the number of sound insulation cells for each target frequency tends to be small, making it difficult to achieve sufficient sound absorption and insulation effect without increasing the overall dimensions of the sound insulation structure. In contrast, the sound absorption and insulation structure described in (1) can achieve the sound absorption effect and the sound insulation effect over a wide range of target frequencies using only a small number of hole types. As a result, even in a limited space, a large number of holes can be provided for each target frequency. Therefore, it is possible to achieve a high sound absorption and insulation effect for frequencies including higher-order components of rotating bodies, while minimizing the size of the sound absorption and insulation structure.
(2) In some embodiments, in the sound absorption and insulation structure described in (1), the first hole (e.g., any of the above-described holes 9N, 9J, 20E, 20F, 20G) includes at least one bending part (e.g., the above-described bending parts 9Nab, 9Nbc, 9Ncd, 9Nde, 9Jab, 9Jbc, 20Eab, 20Ebc, 20Ecd, 20Fab, 20Gab) in which the direction of extension of the first hole changes.

With the sound absorption and insulation structure described in (2), since the first hole includes at least one bending part, it is easy to secure the length of the first hole even if the thickness of the sound absorption and insulation structure from the first surface to the second surface is small, and as compared to the case where the first hole is composed of only one linear part without a bending part, it is possible to obtain the sound absorption and insulation effect for relatively small frequencies while suppressing the increase in thickness of the sound absorption and insulation structure from the first surface to the second surface.
(3) In some embodiments, in the sound absorption and insulation structure described in (2), the first hole (e.g., the above-described holes 9N, 9J, 20E) includes at least two bending parts (e.g., the above-described bending parts 9Nab, 9Nbc, 9Ncd, 9Nde, 9Jab, 9Jbc, 20Eab, 20Ebc, 20Ecd) in which the direction of extension of the first hole changes. The second hole (e.g., holes other than the first hole of the above-described holes 9N, 9J, 20F, 20G) includes at least one bending part (e.g., the above-described bending parts 9Nab, 9Nbc, 9Ncd, 9Nde, 9Jab, 9Jbc, 20Fab, 20Gab) in which the direction of extension of the second hole changes. The number of bending parts included in the first hole is different from the number of bending parts included in the second hole.

With the sound absorption and insulation structure described in (3), since the first hole includes at least two bending parts and the second hole includes at least one bending part, it is easy to secure the lengths of the first hole and the second hole even if the thickness of the sound absorption and insulation structure from the first surface to the second surface is small, and as compared to the case where, for instance, the first hole and the second hole are each composed of only one linear part without a bending part, it is possible to obtain the sound absorption and insulation effect for relatively small frequencies while suppressing the increase in thickness of the sound absorption and insulation structure from the first surface to the second surface.
(4) In some embodiments, in the sound absorption and insulation structure described in any one of (1) to (3), the length of the first hole is not less than 1.5 times and not more than 2.5 times the length of the second hole.

With the sound absorption and insulation structure described in (4), since the length of the first hole is about twice (i.e., not less than 1.5 times and not more than 2.5 times) as long as that of the second hole, high sound absorption and insulation performance can be achieved, for example, for frequencies that include higher-order components of rotating bodies such as fans.
(5) In some embodiments, the sound absorption and insulation structure described in any one of (1) to (4) further includes a third hole (e.g., holes other than the first hole and the second hole of the above-described holes 9N, 9J, 9I, 20E, 20F, 20G) that is open on the first surface and is not open on the second surface, the third hole differing from each of the first hole and the second hole in shape and length.

With the sound absorption and insulation structure described in (5), it is possible to further increase the target frequencies for which the sound absorption and insulation effect can be obtained in the sound absorption and insulation structure described in (1) to (4).
(6) In some embodiments, in the sound absorption and insulation structure described in (5), the length of the first hole (e.g., the above-described holes 9N, 20E) is not less than 1.5 times and not more than 2.5 times the length of the second hole (e.g., the above-described holes 9J, 20F), and the length of the second hole is not less than 1.5 times and not more than 2.5 times the length of the third hole (e.g., the above-described holes 91, 20G).

With the sound absorption and insulation structure described in (6), since the length of the first hole is about twice (i.e., not less than 1.5 times and not more than 2.5 times) as long as that of the second hole, and the length of the second hole is about twice (i.e., not less than 1.5 times and not more than 2.5 times) as long as that of the third hole, high sound absorption and insulation performance can be achieved, for example, for frequencies that include higher-order components of rotating bodies such as fans.
(7) In some embodiments, in the sound absorption and insulation structure described in any one of (1) to (6), the first hole and the second hole extend along the same plane.

With the sound absorption and insulation structure described in (7), by forming the first and second holes so that they extend along the same plane, it becomes easier to periodically arrange the first and second holes to increase their number density.
(8) In some embodiments, in the sound absorption and insulation structure described in any one of (1) to (7), the first hole includes a plurality of passage parts connected in series. The plurality of passage parts includes: a first passage part (e.g., the above-described linear parts 9Na, 9Ja, 20Ea) that is open on the first surface and extends from the first surface toward the second surface along a direction intersecting the first surface; a second passage part (e.g., the above-described linear parts 9Nb, 9Jb, arc-shaped part 20Eb) that extends from an end of the first passage part on the side facing the second surface along a direction intersecting the direction of extension of the first passage part; and a third passage part (e.g., the above-described linear parts 9Nc, 9Jc, 20Ec) that extends from an end of the second passage part on the side away from the first passage part toward the first surface along a direction intersecting the direction of extension of the second passage part.

With the sound absorption and insulation structure described in (8), it is easy to secure the length of the first hole even if the thickness of the sound absorption and insulation structure from the first surface to the second surface is small, and as compared to the case where the first hole is composed of only one linear part without a bending part, it is possible to obtain the sound absorption and insulation effect for relatively small frequencies while suppressing the increase in thickness of the sound absorption and insulation structure from the first surface to the second surface.
(9) In some embodiments, in the sound absorption and insulation structure described in (8), the plurality of passage parts includes: a fourth passage part (e.g., the above-described linear part 9Nd) that extends from an end of the third passage part on the side facing the first surface along a direction intersecting the direction of extension of the third passage part; and a fifth passage part (e.g., the above-described linear parts 9Ne) that extends from an end of the fourth passage part on the side away from the fourth passage part toward the second surface along a direction intersecting the direction of extension of the fourth passage part.

With the sound absorption and insulation structure described in (9), it is easy to secure the length of the first hole even if the thickness of the sound absorption and insulation structure from the first surface to the second surface is small, and as compared to the case where the first hole is composed of only one linear part without a bending part, it is possible to obtain the sound absorption and insulation effect for relatively small frequencies while suppressing the increase in thickness of the sound absorption and insulation structure from the first surface to the second surface.
(10) In some embodiments, in the sound absorption and insulation structure described in (9), the second hole includes a plurality of passage parts connected in series. The plurality of passage parts of the second hole includes: a sixth passage part (e.g., the above-described linear part 9Ja) that is open on the first surface and extends from the first surface toward the second surface along a direction intersecting the first surface; a seventh passage part (e.g., the above-described linear part 9Jb) that extends from an end of the sixth passage part on the side facing the second surface along a direction intersecting the direction of extension of the first passage part; and an eighth passage part (e.g., the above-described linear parts 9Jc) that extends from an end of the seventh passage part on the side away from the sixth passage part toward the first surface along a direction intersecting the direction of extension of the sixth passage part.

With the sound absorption and insulation structure described in (10), it is easy to secure the length of the second hole even if the thickness of the sound absorption and insulation structure from the first surface to the second surface is small, and as compared to the case where the second hole is composed of only one linear part without a bending part, it is possible to obtain the sound absorption and insulation effect for relatively small frequencies while suppressing the increase in thickness of the sound absorption and insulation structure from the first surface to the second surface.
(11) In some embodiments, the sound absorption and insulation structure described in (10) includes a cavity (e.g., the above-described cavity 30) between the eighth passage part and the first surface.

With the sound absorption and insulation structure described in (11), the weight of the sound absorption and insulation structure can be reduced by providing a cavity in the dead space that does not directly contribute to the sound absorption and insulation effect in the configuration described in (10).
(12) In some embodiments, the sound absorption and insulation structure described in (5) or (6) includes a cavity (e.g., the above-described cavity 32) between the third hole and the second surface.

With the sound absorption and insulation structure described in (12), the weight of the sound absorption and insulation structure can be reduced by providing a cavity in the dead space that does not directly contribute to the sound absorption and insulation effect in the configuration described in (5) or (6).
(13) In some embodiments, in the sound absorption and insulation structure described in any one of (1) to (8), the sound absorption and insulation structure is formed in cylindrical shape, the first surface is an inner surface (e.g., the above-described inner surface 14) of the sound absorption and insulation structure, and the second surface is an outer surface (e.g., the above-described outer surface 12) of the sound absorption and insulation structure.

With the sound absorption and insulation structure described in (13), noise can be effectively reduced by the first hole and the second hole formed on the inner surface as described in (1) to (8) when the noise passes on the inner surface side of the sound absorption and insulation structure from one axial end of the cylindrical sound absorption and insulation structure. Therefore, by installing the sound absorption and insulation structure in, for example, an opening of a casing that covers equipment to be subjected to noise reduction, the noise emitted from the opening can be effectively reduced.
(14) In some embodiments, in the sound absorption and insulation structure described in (13), the first hole includes a plurality of passage parts connected in series. The plurality of passage parts includes: a first passage part (e.g., the above-described linear parts 20Ea, 20Fa, 20Ga) that extends from the inner surface outward in the radial direction of the sound absorption and insulation structure; and a second passage part (e.g., the above-described arc-shaped parts 20Eb, 20Fb, 20Gb) that extends from an end of the first passage part on the outer side in the radial direction along the circumferential direction of the sound absorption and insulation structure.

With the sound absorption and insulation structure described in (14), it is easy to secure the length of the first hole even if the thickness of the cylindrical sound absorption and insulation structure from the inner surface to the outer surface is small, and as compared to the case where the first hole is composed of only one linear part without a bending part, it is possible to obtain the sound absorption and insulation effect for relatively small frequencies while suppressing the increase in thickness of the sound absorption and insulation structure from the inner surface to the outer surface and suppressing the increase in size of the sound absorption and insulation structure.
(15) In some embodiments, in the sound absorption and insulation structure described in (14), the second hole includes a plurality of passage parts connected in series. The plurality of passage parts of the second hole includes: a third passage part (e.g., the above-described linear parts 20Fa, 20Ga) that extends from the inner surface outward in the radial direction of the sound absorption and insulation structure and is shorter than the first passage part; and a fourth passage part (e.g., the above-described arc-shaped parts 20Fb, 20Gb) that is located inward of the second passage part in the radial direction and extends from an end of the third passage part on the outer side in the radial direction along the circumferential direction of the sound absorption and insulation structure.

With the sound absorption and insulation structure described in (15), it is easy to secure the length of the second hole even if the thickness of the cylindrical sound absorption and insulation structure from the inner surface to the outer surface is small, and as compared to the case where the second hole is composed of only one linear part without a bending part, it is possible to obtain the sound absorption and insulation effect for relatively small frequencies while suppressing the increase in thickness of the sound absorption and insulation structure from the inner surface to the outer surface and suppressing the increase in size of the sound absorption and insulation structure.
(16) In some embodiments, in the sound absorption and insulation structure described in (15), the plurality of passage parts of the first hole includes: a fifth passage part (e.g., the above-described linear parts 20Ec) that extends from an end of the second passage part on the side away from the first passage part inward in the radial direction.

With the sound absorption and insulation structure described in (16), it is easy to secure the length of the first hole even if the thickness of the cylindrical sound absorption and insulation structure from the inner surface to the outer surface is small, and it is possible to obtain the sound absorption and insulation effect for relatively small frequencies while suppressing the increase in thickness of the sound absorption and insulation structure from the inner surface to the outer surface and suppressing the increase in size of the sound absorption and insulation structure.
(17) In some embodiments, in the sound absorption and insulation structure described in (16), the plurality of passage parts of the first hole includes a sixth passage part (e.g., the above-described linear part 20Ed) that extends from an end of the fifth passage part on the inner side in the radial direction toward the first passage part along the circumferential direction.

With the sound absorption and insulation structure described in (17), it is easy to secure the length of the first hole even if the thickness of the cylindrical sound absorption and insulation structure from the inner surface to the outer surface is small, and it is possible to obtain the sound absorption and insulation effect for relatively small frequencies while suppressing the increase in thickness of the sound absorption and insulation structure from the inner surface to the outer surface and suppressing the increase in size of the sound absorption and insulation structure.
(18) In some embodiments, the sound absorption and insulation structure described in any one of (13) to (17) further includes a third hole (e.g., holes other than the first hole and the second hole of the above-described holes 20E, 20F, 20G) that is open on the inner surface and is not open on the outer surface, the third hole differing from each of the first hole and the second hole in shape and length.

With the sound absorption and insulation structure described in (18), it is possible to further increase the target frequencies for which the sound absorption and insulation effect can be obtained in the sound absorption and insulation structure described in (13) to (17).
(19) In some embodiments, in the sound absorption and insulation structure described in (18), the first hole includes a plurality of passage parts connected in series. The plurality of passage parts of the first hole includes: a first linear part (e.g., the above-described linear part 20Ea) that extends linearly from the inner surface outward in the radial direction of the sound absorption and insulation structure; and a first arc-shaped part (e.g., the above-described arc-shaped parts 20Eb) that extends from an end of the first linear part on the outer side in the radial direction along the circumferential direction of the sound absorption and insulation structure. The second hole includes a plurality of passage parts connected in series. The plurality of passage parts of the second hole includes: a second linear part (e.g., the above-described linear part 20Fa) that extends from the inner surface outward in the radial direction of the sound absorption and insulation structure and is shorter than the first linear part; and a second arc-shaped part (e.g., the above-described arc-shaped part 20Fb) that is located inward of the first arc-shaped part in the radial direction and extends from an end of the second linear part on the outer side in the radial direction along the circumferential direction of the sound absorption and insulation structure. The third hole includes a plurality of passage parts connected in series. The plurality of passage parts of the third hole includes: a third linear part (e.g., the above-described linear part 20Ga) that extends from the inner surface outward in the radial direction of the sound absorption and insulation structure and is shorter than the second linear part; and a third arc-shaped part (e.g., the above-described arc-shaped part 20Gb) that is located inward of the second arc-shaped part in the radial direction and extends from an end of the third linear part on the outer side in the radial direction along the circumferential direction of the sound absorption and insulation structure.

With the sound absorption and insulation structure described in (19), the first, second, and third holes with different lengths and different shapes can be efficiently arranged in the same plane perpendicular to the axial direction in the cylindrical sound absorption and insulation structure, so it is possible to achieve a high sound absorption and insulation effect, while minimizing the size of the sound absorption and insulation structure.
(20) In some embodiments, the sound absorption and insulation structure described in (19) includes a cavity (e.g., the above-described cavities 34, 36) formed between the second hole and the third hole.

With the sound absorption and insulation structure described in (20), the weight of the sound absorption and insulation structure can be reduced by providing a cavity in the dead space that does not directly contribute to the sound absorption and insulation effect in the configuration described in (19).

Reference Signs List

| 2A, 2B | Sound absorption and insulation structure |
|---|---|
| 4, 22 | Sound absorption and insulation structure unit part |
| 6 | First surface |
| 6a | First surface part |
| 8 | Second surface |
| 8a | Second surface part |
| 9, 9I, 9J, 9N | Hole |
| 9I2, 9J2, 9N2 | Closed end |
| 9I1, 9J1, 9N1 | Open end |
| 9Ia, 9Ja, 9Jb, 9Jc, 9Na, 9Nb, 9Nc, 9Nd, 9Ne | Linear part |
| 9Jab, 9Jbc, 9Nab, 9Nbc, 9Ncd, 9Nde | Bending part |
| 12 | Outer surface |
| 12a | Outer surface part |
| 14 | Inner surface |
| 14a | Inner surface part |
| 16 | One end surface |
| 18 | Other end surface |
| 20, 20E, 20F, 20G | Hole |
| 20E2, 20F2, 20G2 | Closed end |
| 20E1, 20F1, 20G1 | Open end |
| 20Ea, 20Eb, 20Ec, 20Ed, 20Fa, 20Ga | Linear part |
| 20Eb, 20Ed, 20Fb, 20Gb, 20Gd | Arc-shaped part |
| 20Eab, 20Ebc, 20Ecd, 20Fab, 20Gab | Bending part |
| 24 | Sound absorption and insulation structural layer |
| 30, 32, 34, 36 | Cavity |

1. A sound absorption and insulation structure, comprising:
a first surface;
a second surface disposed opposite the first surface;
a first hole that is open on the first surface and is not open on the second surface; and
a second hole that is open on the first surface and is not open on the second surface, the second hole differing from the first hole in shape and length, wherein
the first hole includes a plurality of passage parts connected in series,
the plurality of passage parts includes:
a first passage part that is open on the first surface and extends from the first surface toward the second surface along a direction intersecting the first surface;
a second passage part that extends from an end of the first passage part on a side facing the second surface along a direction intersecting a direction of extension of the first passage part;
a third passage part that extends from an end of the second passage part on a side away from the first passage part toward the first surface along a direction intersecting a direction of extension of the second passage part;
a fourth passage part that extends from an end of the third passage part on a side facing the first surface along a direction intersecting a direction of extension of the third passage part; and
a fifth passage part that extends from an end of the fourth passage part on a side away from the third passage part toward the second surface along a direction intersecting a direction of extension of the fourth passage part,
the second hole includes a plurality of passage parts connected in series,
the plurality of passage parts of the second hole includes:
a sixth passage part that is open on the first surface and extends from the first surface toward the second surface along a direction intersecting the first surface;
a seventh passage part that extends from an end of the sixth passage part on a side facing the second surface along a direction intersecting a direction of extension of the first passage part; and
an eighth passage part that extends from an end of the seventh passage part on a side away from the sixth passage part toward the first surface along a direction intersecting a direction of extension of the seventh passage part, and
the sound absorption and insulation structure comprises a cavity between the eighth passage part and the first surface.

2.-3. (canceled)

4. The sound absorption and insulation structure according to claim 1, wherein the length of the first hole is not less than 1.5 times and not more than 2.5 times the length of the second hole.

5. The sound absorption and insulation structure according to claim 1, further comprising a third hole that is open on the first surface and is not open on the second surface, the third hole differing from each of the first hole and the second hole in shape and length.

6. The sound absorption and insulation structure according to claim 5, wherein
the length of the first hole is not less than 1.5 times and not more than 2.5 times the length of the second hole, and
the length of the second hole is not less than 1.5 times and not more than 2.5 times the length of the third hole.

7. The sound absorption and insulation structure according to claim 1, wherein the first hole and the second hole extend along the same plane.

8.-11. (canceled)

12. The sound absorption and insulation structure according to claim 5, further comprising a cavity between the third hole and the second surface.

13. The sound absorption and insulation structure according to claim 1, wherein
the sound absorption and insulation structure is formed in cylindrical shape,
the first surface is an inner surface of the sound absorption and insulation structure, and
the second surface is an outer surface of the sound absorption and insulation structure.

14. The sound absorption and insulation structure according to claim 13, wherein
the first passage part extends from the inner surface outward in a radial direction of the sound absorption and insulation structure; and
the second passage part extends from an end of the first passage part on an outer side in the radial direction along a circumferential direction of the sound absorption and insulation structure.

15. The sound absorption and insulation structure according to claim 14, wherein
the sixth passage part extends from the inner surface outward in the radial direction of the sound absorption and insulation structure and is shorter than the first passage part; and
the seventh passage part is located inward of the second passage part in the radial direction and extends from an end of the sixth passage part on an outer side in the radial direction along the circumferential direction of the sound absorption and insulation structure.

16. The sound absorption and insulation structure according to claim 15, wherein the third passage part extends from an end of the second passage part on a side away from the first passage part inward in the radial direction.

17. The sound absorption and insulation structure according to claim 16, wherein the fourth passage part extends from an end of the third passage part on an inner side in the radial direction toward the first passage part along the circumferential direction.

18. The sound absorption and insulation structure according to claim 13, further comprising a third hole that is open on the inner surface and is not open on the outer surface, the third hole differing from each of the first hole and the second hole in shape and length.

19. The sound absorption and insulation structure according to claim 18, wherein
the first passage part extends linearly from the inner surface outward in a radial direction of the sound absorption and insulation structure,
the second passage part extends from an end of the first passage part on an outer side in the radial direction along a circumferential direction of the sound absorption and insulation structure,
the sixth passage part extends from the inner surface outward in the radial direction of the sound absorption and insulation structure and is shorter than the first passage part,
the seventh passage part is located inward of the second passage part in the radial direction and extends from an end of the sixth passage part on an outer side in the radial direction along the circumferential direction of the sound absorption and insulation structure,
the third hole includes a plurality of passage parts connected in series, and
the plurality of passage parts of the third hole includes:
a linear part that extends from the inner surface outward in the radial direction of the sound absorption and insulation structure and is shorter than the sixth passage part; and
an arc-shaped part that is located inward of the seventh passage part in the radial direction and extends from an end of the linear part on an outer side in the radial direction along the circumferential direction of the sound absorption and insulation structure.

20. The sound absorption and insulation structure according to claim 19, comprising a cavity formed between the second hole and the third hole.
